(19) United States
(12) Patent Application Publication
(10) Pub. No.: US 2017/0198537 A1
(43) Pub. Date: Jul. 13, 2017

(54) MAGNETIC ATTACHMENT SYSTEM FOR COMMUNICATION THROUGH HYDROCARBON PRODUCTION SYSTEMS

(71) Applicant: Schlumberger Technology Corporation, Sugar Land, TX (US)

(72) Inventor: Laura Schoellmann, Pearland, TX (US)

(21) Appl. No.: 15/399,351

(22) Filed: Jan. 5, 2017

Related U.S. Application Data
(60) Provisional application No. 62/277,084, filed on Jan. 11, 2016.

(51) Int. Cl. E21B 23/01; E21B 47/14; G08C 23/02

(52) U.S. Cl. CPC E21B 23/01; G08C 23/02; E21B 47/14; E21B 17/01

(57) ABSTRACT

Embodiments of the present disclosure may provide an acoustic transceiver system and a method for installing the acoustic transceiver system. The acoustic transceiver system may include at least one acoustic transceiver. The acoustic transceiver system may also include at least one magnet coupled to the at least one acoustic transceiver. The magnet may attach the at least one acoustic transceiver to a component of a hydrocarbon production system.

### CROSS-REFERENCE TO RELATED APPLICATIONS

This application claims the benefit of U.S. Provisional Patent Application No. 62/277,084 filed Jan. 11, 2016, of which is herein incorporated by reference in its entirety.

### BACKGROUND

Currently, acoustic transceivers provide a communications pathway for devices used in hydrocarbon production systems. For example, acoustic transceivers may be attached to an external surface of a marine riser to communicate with tools, strings, and other devices within the marine riser. Transceivers may also be attached to the subsea test tree (SSTT) or blow-out prevention (BOP) stack to communicate with tools inside those respective elements of the hydrocarbon production system.

The acoustic transceivers are attached to the external surface of the marine riser or blow out preventer BOP. Also, the acoustic transceivers are attached prior to the installation of the marine riser/BOP. This, however, reduces flexibility in repairing or changing the acoustic transceivers. If problems occur in the acoustic transceivers, the marine riser/BOP may have to be taken out of production to repair the acoustic transceivers.

### SUMMARY

Embodiments of the present disclosure may provide an acoustic transceiver system. The acoustic transceiver system may include at least one acoustic transceiver. The acoustic transceiver system may also include at least one magnet coupled to the at least one acoustic transceiver. The magnet attaches the at least one acoustic transceiver to a component of a hydrocarbon production system.

In an embodiment, a substrate may be coupled to the at least one acoustic transceiver and the at least one magnet. A rear surface of the substrate may be shaped to fit an external surface of the component of the hydrocarbon production system.

In an embodiment, a blocking plate may be positioned between the rear surface of the substrate and the external surface of the component of the hydrocarbon production system.

In an embodiment, the at least one magnet may cover the rear surface of the substrate.

In an embodiment, the at least one magnet may include at least one electro-magnet.

In an embodiment, a power source may be coupled to the at least one electro-magnet.

In an embodiment, a modem may be coupled to the at least one acoustic transceiver and communicate with a control device.

In an embodiment, the component of the hydrocarbon production system may be a marine riser.

In an embodiment, the component of the hydrocarbon production system may be a subsea tree.

In an embodiment, the component of the hydrocarbon production system may be a blowout preventer.

Embodiments of the present disclosure may provide a method for installing a communications system. The method may include positioning an acoustic transceiver system on an external surface of a component of a hydrocarbon production system. The method may also include enabling at least one magnet of the acoustic transceiver system to attach the acoustic transceiver system on the external surface of the component of the hydrocarbon production system.

In an embodiment, the positioning of the acoustic transceiver system may be performed by a remote operated vehicle.

In an embodiment, at least one of the positioning of the acoustic transceiver system and enabling of the at least one magnet may be performed by a remote operated vehicle.

In an embodiment, the enabling of the at least one magnet may include removing a blocking plate positioned between the at least one magnet and the external surface of the component of the hydrocarbon production system.

In an embodiment, the enabling of the at least one magnet may include enabling power to the at least one magnet.

In an embodiment, the component of the hydrocarbon production system may be a marine riser.

In an embodiment, the component of the hydrocarbon production system may be a subsea tree.

In an embodiment, the component of the hydrocarbon production system may be a blowout preventer.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A-1C illustrate several views of an example of an acoustic transceiver system, according to an embodiment.

FIGS. 2A-2C illustrate several views of another example of an acoustic transceiver system, according to an embodiment.

FIGS. 3A-3C illustrate several views of another example of an acoustic transceiver system, according to an embodiment.

FIGS. 4A and 4B illustrate several views of another example of an acoustic transceiver system, according to an embodiment.

FIGS. 5A and 5B illustrate several views of another example of an acoustic transceiver system, according to an embodiment.

FIGS. 6A and 6B illustrate several views of another example of an acoustic transceiver system, according to an embodiment.

FIGS. 7A and 7B illustrate several examples of configurations for acoustic transceiver systems installed on a marine riser, according to an embodiment.

FIG. 8 illustrates a flowchart of a method for installing one or more acoustic transceiver systems, according to an embodiment.

FIG. 9 illustrates an example of an installation of an acoustic transceiver system on a marine riser in production, according to an embodiment.

### DETAILED DESCRIPTION

Reference will now be made in detail to the various embodiments in the present disclosure, examples of which are illustrated in the accompanying drawings and figures. The embodiments are described below to provide a more complete understanding of the components, processes and apparatuses disclosed herein. Any examples given are intended to be illustrative, and not restrictive. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

Throughout the specification and claims, the following terms take the meanings explicitly associated herein, unless the context clearly dictates otherwise. The phrases “in some embodiments” and “in an embodiment” as used herein do not necessarily refer to the same embodiment(s), though they may. Furthermore, the phrases “in another embodiment” and “in some other embodiments” as used herein do not necessarily refer to a different embodiment, although they may. As described below, various embodiments may be readily combined, without departing from the scope or spirit of the present disclosure.

As used herein, the term “or” is an inclusive operator, and is equivalent to the term “and/or,” unless the context clearly dictates otherwise. The term “based on” is not exclusive and allows for being based on additional factors not described, unless the context clearly dictates otherwise. In the specification, the recitation of “at least one of A, B, and C,” includes embodiments containing A, B, or C, multiple examples of A, B, or C, or combinations of A/B, A/C, B/C, A/B/B/BB/C, AB/C, etc. In addition, throughout the specification, the meaning of “a,” “an,” and “the” include plural references. The meaning of “in” includes “in” and “on.”

It will also be understood that, although the terms first, second, etc. may be used herein to describe various elements, these elements should not be limited by these terms. These terms are used to distinguish one element from another. For example, a first object or step could be termed a second object or step, and, similarly, a second object could be termed a first object, without departing from the scope of the invention. The first object and the second object are both objects, but they are not to be considered the same object. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

When referring to any numerical range of values herein, such ranges are understood to include each and every number and/or fraction between the stated range minimum and maximum. For example, a range of 0.5-6% would expressly include intermediate values of 0.6%, 0.7%, and 0.9%, up to and including 5.95%, 5.97%, and 5.99%. The same applies to each other numerical property and/or elemental range set forth herein, unless the context clearly dictates otherwise.

Attention is now directed to processing procedures, methods, techniques, and workflows that are in accordance with some embodiments. Some operations in the processing procedures, methods, techniques, and workflows disclosed herein may be combined and/or the order of some operations may be changed.

In embodiments, an acoustic transceiver system may include a magnetic attachment system that allows the acoustic transceiver to be attached to an external surface of components of a hydrocarbon production system. In embodiment, the components of the hydrocarbon production system may include marine risers, subsea test trees, blow out preventers, hydrocarbon pipelines, and any other system that includes a surface, which allows attachment of a magnet, for example, a ferromagnetic surface. In embodiments, the acoustic transceiver system may include a rear surface to conform to an external surface of the components of the hydrocarbon production system. In embodiments, the acoustic transceiver system may include one or more magnets, magnetic materials, electromagnets, etc. positioned approximate to the rear surface of the acoustic transceiver system to attach the external surface of the components of the hydrocarbon production system.

In embodiments, the acoustic transceiver system may be installed before or during the operation of the component of the hydrocarbon production system. As such, the acoustic transceiver system may be installed without halting the operation of the component. Similarly, the acoustic transceiver system may be removed without halting operations to retrieve the component of the hydrocarbon production system. Likewise, this allows replacement of acoustic transceiver system without pulling the component. For example, in a marine riser, subsea test tree, blow out preventers, hydrocarbon pipelines, etc., the acoustic transceiver system may be installed, removed and replaced by deploying a remote operated vehicle (ROV). This may reduce operational time and potential non-productive time of the component.

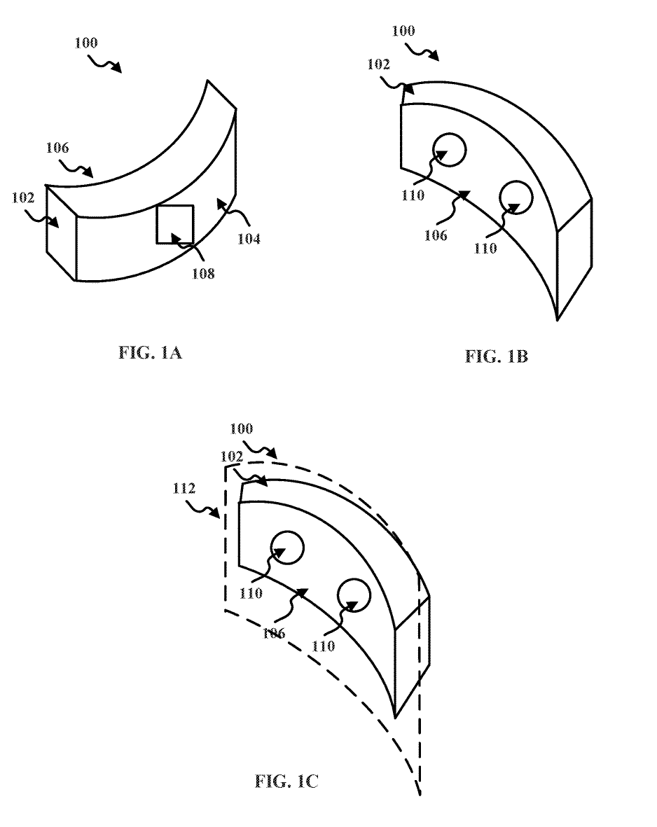

FIGS. 1A-1C illustrate several views of an example of an acoustic transceiver system 100, according to an embodiment. FIG. 1A illustrates a front view of the acoustic transceiver system 100. As illustrated in FIG. 1A, the acoustic transceiver system 100 may be formed of a substrate 102. The substrate 102 may be formed of any magnetic material, non-magnetic material, or combination thereof. The substrate 102 may include a front surface 104 and a rear surface 106. In embodiments, the rear surface 106 may be formed in a shape that allows the rear surface 106 of the acoustic transceiver system 100 to contact an external surface of a component of a hydrocarbon production system. For example, in some embodiments, the rear surface 106 may be formed in a curved shape for attachment to an external surface of a marine riser.

The acoustic transceiver system 100 may include an acoustic transceiver circuit 108. The acoustic transceiver circuit 108 may be fixed to the front surface 104 of the substrate 102. In other embodiments, the acoustic transceiver circuit 108 may be located internally within the substrate 102. The acoustic transceiver circuit 108 may include hardware and software to generate and receive acoustic signals. In some embodiments, the acoustic transceiver circuit 108 may send acoustic signals to devices located within the component of the hydrocarbon production system. In some embodiments, the acoustic transceiver circuit 108 may receive the acoustic signal from devices located within the component of the hydrocarbon production system. The acoustic transceiver circuit 108 may enable communications with the devices located with the component of the hydrocarbon production system. For example, the acoustic transceiver circuit 108 may enable communications with devices within a marine riser such as tools, strings, and other devices located within the marine riser.

FIG. 1B illustrates a rear view of the acoustic transceiver system 100. As illustrated in FIG. 1B, the rear surface 106 of the substrate 102 may include one or more magnets 110. The one or more magnets 110 may be formed of any ferromagnetic material, for example, iron, nickel, cobalt, alloys of rare earth metals, and the like. In some embodiments, the one or more magnets 110 may be positioned within the substrate 102 approximate to the rear surface 106. The one or more magnets 100 may enable the acoustic transceiver system 100 to be attached to an external surface of a component of a hydrocarbon production system. The one or more magnets 110 may include any number of magnets to attach the acoustic transceiver system 100 to an external surface of a component of a hydrocarbon production system.

The acoustic transceiver system 100 may include a blocking device that is fixed to the acoustic transceiver system 100 prior to installation and removed once the acoustic transceiver system 100 is positioned on the external surface of a component of a hydrocarbon production system. The blocking device may facilitate the installation of the acoustic transceiver system 100 by blocking the magnetic field of the acoustic transceiver system 100 until the acoustic transceiver system 100 is in place and the blocking device is removed.

FIG. 1C illustrates one example of a blocking device 112, according to an embodiment. As illustrated in FIG. 1C, the blocking device 112 may be positioned over the rear surface 106 of the substrate 102. The blocking device 112 may be formed of a material that blocks the magnetic field. The blocking device 112 may be removably attached to the rear surface 106 of the substrate 102 to allow the blocking device 112 to be removed during installation. The blocking device may be formed in a shape that matches the shape of the rear surface 106 of the substrate 102. For example, the blocking device 112 may be formed in a curved shape for attachment to an external surface of a marine riser. The blocking device 112 may be formed larger than the substrate 102 to allow the blocking device 112 to be removed during installation.

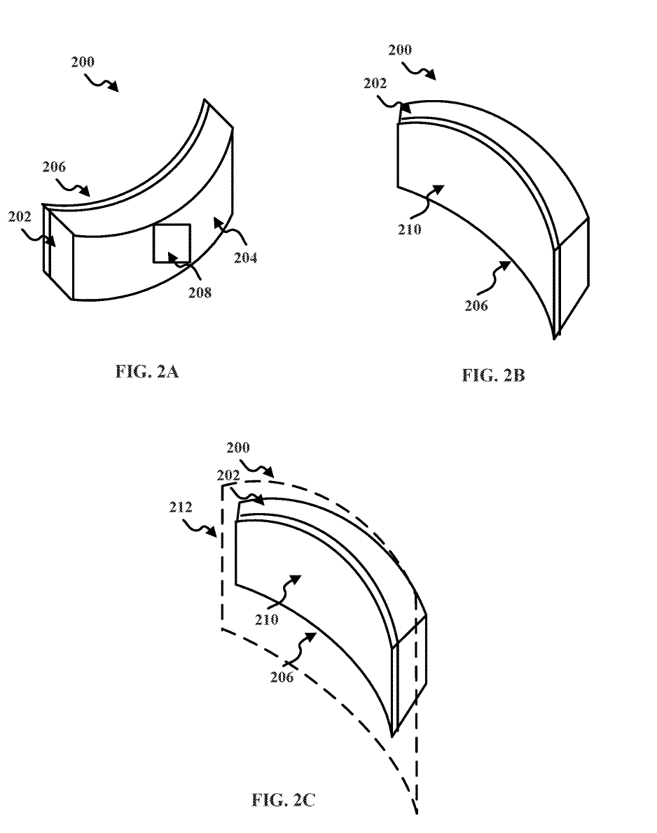

FIGS. 2A-2C illustrate several views of another example of an acoustic transceiver system 200, according to an embodiment. FIG. 2A illustrates a front view of the acoustic transceiver system 200. As illustrated in FIG. 2A, the acoustic transceiver system 200 may be formed of a substrate 202. The substrate 202 may be formed of any magnetic material, non-magnetic material, or combination thereof. The substrate 202 may include a front surface 204 and a rear surface 206. The rear surface 206 may be formed in a shape that allows the rear surface 206 of the acoustic transceiver system 200 to contact an external surface of a component of a hydrocarbon production system. For example, the rear surface 206 may be formed in a curved shape for attachment to an external surface of a marine riser.

The acoustic transceiver system 200 may include an acoustic transceiver circuit 208. The acoustic transceiver circuit 208 may be fixed to the front surface 204 of the substrate 202. In some embodiments, the acoustic transceiver circuit 208 may be located internally within the substrate 202. The acoustic transceiver circuit 208 may include hardware and software to generate and receive acoustic signals. The acoustic transceiver circuit 208 may send acoustic signals to devices located within the component of the hydrocarbon production system. The acoustic transceiver circuit 208 may receive the acoustic signal from devices located within the component of the hydrocarbon production system. The acoustic transceiver circuit 208 may enable communications with the devices located with the component of the hydrocarbon production system. For example, the acoustic transceiver circuit 208 may enable communications with devices within a marine riser such as tools, strings, and other devices located within the marine riser.

FIG. 2B illustrates a rear view of the acoustic transceiver system 200. As illustrated in FIG. 2B, the rear surface 206 of the substrate 202 may include a magnetic 210. The magnet 210 may be formed of any ferromagnetic material, for example, iron, nickel, cobalt, alloys of rare earth metals, and the like. In some embodiments, the magnet 210 may be formed in the same shape and size as the rear surface 206. The magnet 210 may enable the acoustic transceiver system 200 to be attached to an external surface of a component of a hydrocarbon production system. The magnet 210 may be attached to the rear surface 206.

The acoustic transceiver system 200 may include a blocking device that is fixed to the acoustic transceiver system 200 prior to installation and removed once the acoustic transceiver system 200 is positioned on the external surface of a component of a hydrocarbon production system. The blocking device may facilitate the installation of the acoustic transceiver system 200 by blocking the magnetic field of the acoustic transceiver system 200 until the acoustic transceiver system 200 is in place and the blocking device is removed.

FIG. 2C illustrates one example of a blocking device 212 according to an embodiment. As illustrated in FIG. 2C, the blocking device 212 may be positioned over the rear surface 206 of the substrate 202. The blocking device 212 may be formed of a material that blocks the magnetic field. The blocking device 212 may be removably attached to the rear surface 206 of the substrate 202 to allow the blocking device 212 to be removed during installation. The blocking device may be formed in a shape that matches the shape of the rear surface 206 and the magnet 210 of the substrate 202. For example, in some embodiments, the blocking device 212 may be formed in a curved shape for attachment to an external surface of a marine riser.

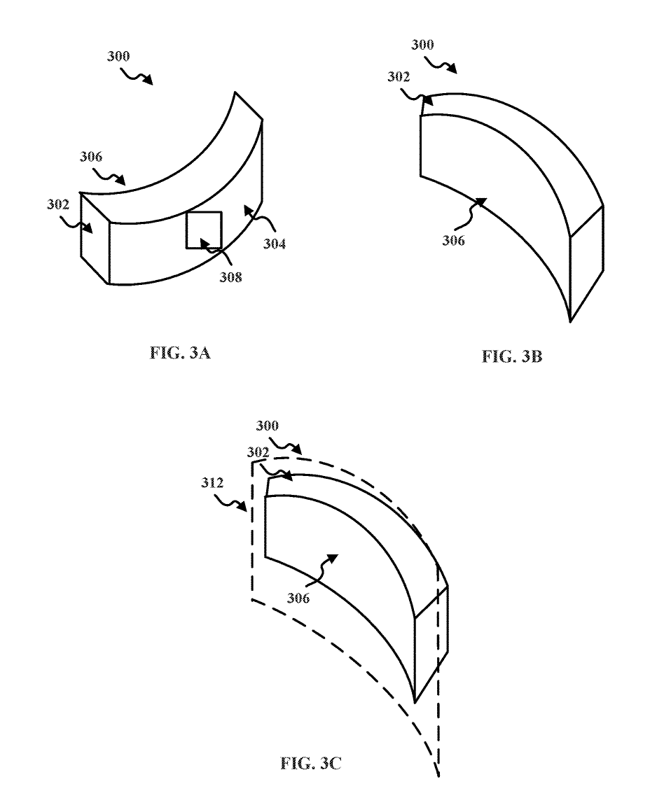

FIGS. 3A-3C illustrate several views of another example of an acoustic transceiver system 300, according to an embodiment. FIG. 3A illustrates a front view of the acoustic transceiver system 300. As illustrated in FIG. 3A, the acoustic transceiver system 300 may be formed of a substrate 302. In this example, the substrate 302 may serve as the one or more magnets of the acoustic transceiver system 300. The substrate 302 may be formed of any ferromagnetic material, for example, iron, nickel, cobalt, alloys of rare earth metals, and the like. The substrate 302 may include a front surface 304 and a rear surface 306. As illustrated in FIG. 3B, the rear surface 306 may be formed in a shape that allows the rear surface 306 of the acoustic transceiver system 300 to contact an external surface of a component of a hydrocarbon production system. For example, the rear surface 306 may be formed in a curved shape for attachment to an external surface of a marine riser.

The acoustic transceiver system 300 may include an acoustic transceiver circuit 308. The acoustic transceiver circuit 308 may be fixed to the front surface 304 of the substrate 302. In some embodiments, the acoustic transceiver circuit 308 may be located internally within the substrate 302. The acoustic transceiver circuit 308 may include hardware and software to generate and receive acoustic signals. The acoustic transceiver circuit 308 may send acoustic signals to devices located within the component of the hydrocarbon production system. The acoustic transceiver circuit 308 may receive the acoustic signal from devices located within the component of the hydrocarbon production system. The acoustic transceiver circuit 308 may enable communications with the devices located with the component of the hydrocarbon production system. For example, the acoustic transceiver circuit 308 may enable communications with devices within a marine riser such as tools, strings, and other devices located within the marine riser.

The acoustic transceiver system 300 may include a blocking device that is fixed to the acoustic transceiver system 300 prior to installation and removed once the acoustic transceiver system 300 is positioned on the external surface of a component of a hydrocarbon production system. The blocking device may facilitate the installation of the acoustic transceiver system 300 by blocking the magnetic field of the acoustic transceiver system 300 until the acoustic transceiver system 300 is in place and the blocking device is removed.

FIG. 3C illustrates one example of a blocking device 312 according to an embodiment. As illustrated in FIG. 3C, the blocking device 312 may be positioned over the rear surface 306 of the substrate 302. The blocking device 312 may be formed of a material that blocks the magnetic field. The blocking device 312 may be removably attached to the rear surface 306 of the substrate 302 to allow the blocking device 312 to be removed during installation. The blocking device may be formed in a shape that matches the shape of the rear surface 306 of the substrate 302. For example, in some embodiments, the blocking device 312 may be formed in a curved shape for attachment to an external surface of a marine riser.

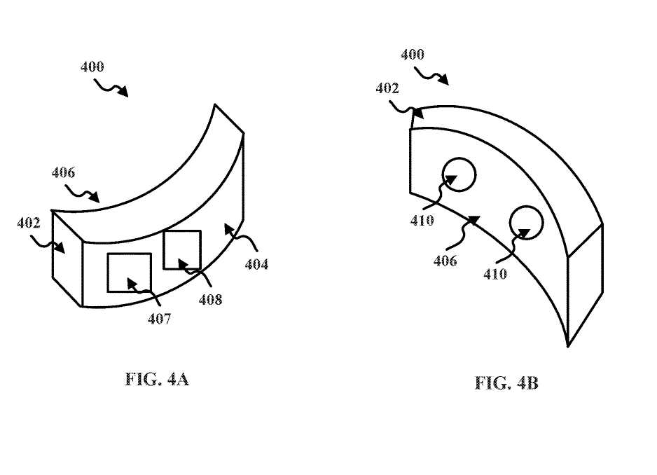

FIGS. 4A and 4B illustrate several views of another example of an acoustic transceiver system 400, according to an embodiment. The acoustic transceiver system 400 may utilize electro-magnets for installation and attachment to a component of a hydrocarbon production system.

FIG. 4A illustrates a front view of the acoustic transceiver system 400. As illustrated in FIG. 4A, the acoustic transceiver system 400 may be formed of a substrate 402. The substrate 402 may be formed of any magnetic material, non-magnetic material, or combination thereof. The substrate 402 may include a front surface 404 and a rear surface 406. The rear surface 406 may be formed in a shape that allows the rear surface 406 of the acoustic transceiver system 400 to contact an external surface of a component of a hydrocarbon production system. For example, the rear surface 406 may be formed in a curved shape for attachment to an external surface of a marine riser.

The acoustic transceiver system 400 may include an acoustic transceiver circuit 408. The acoustic transceiver circuit 408 may be fixed to the front surface 404 of the substrate 402. In some embodiments, the acoustic transceiver circuit 408 may be located internally within the substrate 402. The acoustic transceiver circuit 408 may include hardware and software to generate and receive acoustic signals. The acoustic transceiver circuit 408 may send acoustic signals to devices located within the component of the hydrocarbon production system. The acoustic transceiver circuit 408 may receive the acoustic signal from devices located within the component of the hydrocarbon production system. The acoustic transceiver circuit 408 may enable communications with the devices located with the component of the hydrocarbon production system. For example, the acoustic transceiver circuit 408 may enable communications with devices within a marine riser such as tools, strings, and other devices located with in the marine riser.

The acoustic transceiver system 400 may include a power source 407. The power source 407 may be any type of power source to provide power to components of the acoustic transceiver system 400. As illustrated, the power source 407 may be positioned within the substrate 402. In other embodiments, the power source 407 may be located external to the acoustic transceiver system 400 and coupled to the acoustic transceiver system 400, for example, by a wireline.

FIG. 4B illustrates a rear view of the acoustic transceiver system 400. As illustrated in FIG. 4B, the rear surface 406 of the substrate 402 may include one or more magnets 410. The one or more magnets 410 may be an electro-magnetic that generates an electric filed once current is supplied to the magnet 410. For example, the one or more magnets 410 may be formed of a magnetic material, for example, iron, nickel, cobalt, alloys of rare earth metals, and the like that are surrounded by closely spaced turns of a wire. In some embodiments, the one or more magnets 410 may receive power from the power source 407. In some embodiments, the one or more magnets 410 may be positioned within the substrate approximate to the rear surface 406. The one or more magnets 400 may enable the acoustic transceiver system 400 to be attached to an external surface of a component of a hydrocarbon production system. In embodiments, the one or more magnets 410 may include any number of magnets required to attach the acoustic transceiver system 400 to an external surface of a component of a hydrocarbon production system.

The electromagnetic properties of the one or more magnets 410 may be utilized in the installation of the acoustic transceiver system 400. Prior installation, the one or more magnets 410 may be unpowered thereby not producing an electric field. Once the acoustic transceiver system 400 is positioned on the external surface of a component of a hydrocarbon production system, the one or more magnets may be suppled power to generate a magnetic field and enable attachment.

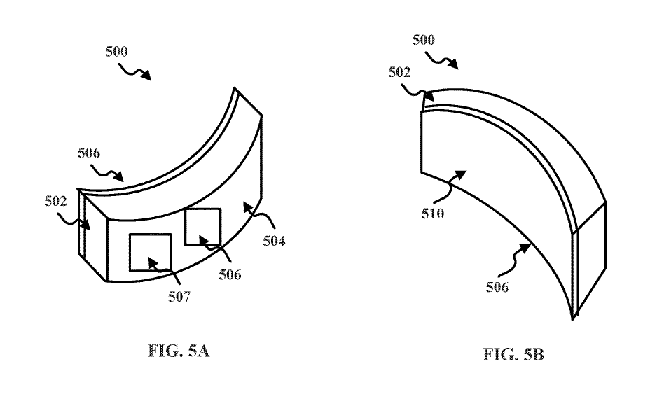

FIGS. 5A and 5B illustrate several views of another example of an acoustic transceiver system 500, according to an embodiment. According to an embodiment, the acoustic transceiver system 500 may utilize electro-magnets for installation and attachment to a component of a hydrocarbon production system.

FIG. 5A illustrates a front view of the acoustic transceiver system 500. As illustrated in FIG. 5A, the acoustic transceiver system 500 may be formed of a substrate 502. The substrate 502 may be formed of any magnetic material, non-magnetic material, or combination thereof. The substrate 502 may include a front surface 504 and a rear surface 506. The rear surface 506 may be formed in a shape that allows the rear surface 506 of the acoustic transceiver system 500 to contact an external surface of a component of a hydrocarbon production system. For example, the rear surface 506 may be formed in a curved shape for attachment to an external surface of a marine riser.

The acoustic transceiver system 500 may include an acoustic transceiver circuit 508. The acoustic transceiver circuit 508 may be fixed to the front surface 504 of the substrate 502. The acoustic transceiver circuit 508 may be located internally within the substrate 502. The acoustic transceiver circuit 508 may include hardware and software to generate and receive acoustic signals. The acoustic transceiver circuit 508 may send acoustic signals to devices located within the component of the hydrocarbon production system. The acoustic transceiver circuit 508 may receive the acoustic signal from devices located within the component of the hydrocarbon production system. The acoustic transceiver circuit 508 may enable communications with the devices located with the component of the hydrocarbon production system. For example, the acoustic transceiver circuit 508 may enable communications with devices within a marine riser such as tools, strings, and other devices located with in the marine riser.

The acoustic transceiver system 500 may include a power source 507. The power source 507 may be any type of power source to provide power to components of the acoustic transceiver system 500. In some embodiments, the power source 507 may be positioned within the substrate 502. In other embodiments, the power source 507 may be located external to the acoustic transceiver system 500 and coupled to the acoustic transceiver system 500, for example, by a wireline.

FIG. 5B illustrates a rear view of the acoustic transceiver system 500. As illustrated in FIG. 5B, the rear surface 506 of the substrate 502 may include a magnet 510. The magnet 510 may be an electro-magnetic that generates an electric field once current is supplied to the magnet 510. For example, the magnet 510 may be formed of a magnetic material, for example, iron, nickel, cobalt, alloys of rare earth metals, and the like that are surrounded by closely spaced turns of a wire. In some embodiments, the magnet 510 may receive power from the power source 507. In some embodiments, the magnet 510 may be formed in the same shape and size as the rear surface 506. The magnetic 510 may enable the acoustic transceiver system 500 to be attached to an external surface of a component of a hydrocarbon production system. In embodiments, the magnetic 510 may be attached to the rear surface 506.

The electromagnetic properties of the magnet 510 may be utilized in the installation of the acoustic transceiver system 500. Prior to installation, the magnet 510 may be unpowered, thereby not producing an electric field. Once the acoustic transceiver system 500 is positioned on the external surface of a component of a hydrocarbon production system, the magnet 500 may be suppled power to generate a magnetic field and enable attachment.

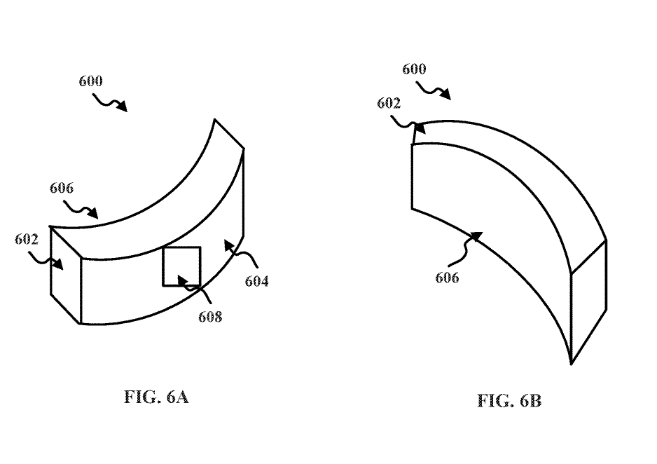

FIGS. 6A and 6B illustrate several views of another example of an acoustic transceiver system 600, according to an embodiment. According to an embodiment, the acoustic transceiver system 600 may utilize electro-magnets for installation and attachment to a component of a hydrocarbon production system.

FIG. 6A illustrates a front view of the acoustic transceiver system 600. As illustrated in FIG. 6A, the acoustic transceiver system 600 may be formed of a substrate 602. In this example, the substrate 602 may serve as the one or more magnets of the acoustic transceiver system 600. The substrate 602 may include a front surface 604 and a rear surface 606. As illustrated in FIG. 6B, the rear surface 606 may be formed in a shape that allows the rear surface 606 of the acoustic transceiver system 600 to contact an external surface of a component of a hydrocarbon production system. For example, the rear surface 606 may be formed in a curved shape for attachment to an external surface of a marine riser.

The acoustic transceiver system 600 may include an acoustic transceiver circuit 608. The acoustic transceiver circuit 608 may be fixed to the front surface 604 of the substrate 602. The acoustic transceiver circuit 608 may be located internally within the substrate 602. The acoustic transceiver circuit 608 may include hardware and software to generate and receive acoustic signals. The acoustic transceiver circuit 608 may send acoustic signals to devices located within the component of the hydrocarbon production system. The acoustic transceiver circuit 608 may receive the acoustic signal from devices located within the component of the hydrocarbon production system. The acoustic transceiver circuit 608 may enable communications with the devices located with the component of the hydrocarbon production system. For example, the acoustic transceiver circuit 608 may enable communications with devices within a marine riser such as tools, strings, and other devices located with in the marine riser.

The acoustic transceiver system 600 may include a power source 607. The power source 607 may be any type of power source to provide power to components of the acoustic transceiver system 600. In some embodiments, the power source 607 may be positioned within the substrate 602. In other embodiments, the power source 607 may be located external to the acoustic transceiver system 500 and coupled to the acoustic transceiver system 600, for example, by a wireline.

The substrate 602, itself, may be an electro-magnetic that generates an electric field once current is supplied to the substrate 602. For example, the substrate 602 may be partially formed of a magnetic material, for example, iron, nickel, cobalt, alloys of rare earth metals, and the like that are surrounded by closely spaced turns of a wire. In some embodiments, the substrate 602 may receive power from the power source 607. The substrate 602 may enable the acoustic transceiver system 600 to be attached to an external surface of a component of a hydrocarbon production system.

The electromagnetic properties of the substrate 602 may be utilized in the installation of the acoustic transceiver system 600. Prior to installation, the substrate 602 may be unpowered, thereby not producing an electric field. Once the acoustic transceiver system 600 is positioned on the external surface of a component of a hydrocarbon production system, the substrate 602 may be suppled power to generate a magnetic field and enable attachment.

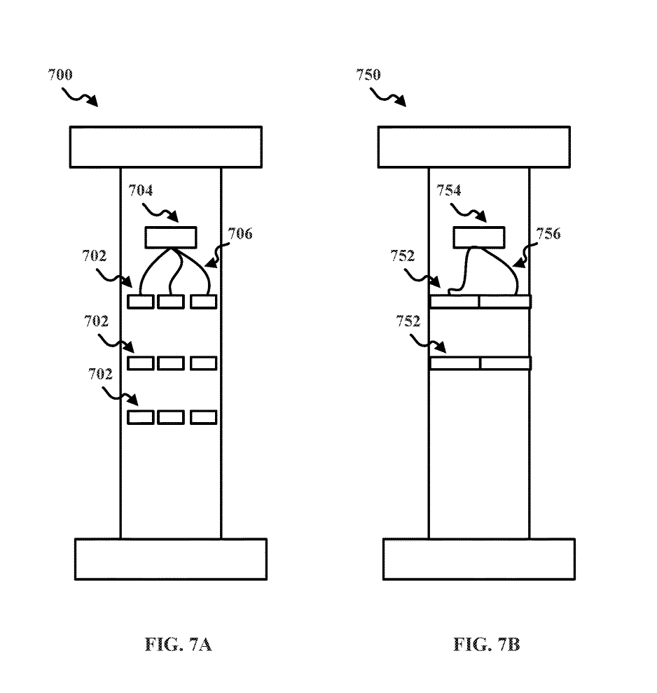

As discussed above, any of the acoustic transceiver systems may be attached to any type of a component of a hydrocarbon production system. Likewise, the size and configuration of the acoustic transceiver system may be determined based on a type of the component of hydrocarbon production system. FIGS. 7A and 7B illustrate several examples of configurations for acoustic transceiver systems installed on a marine riser, according to an embodiment.

As illustrated in FIG. 7A, a marine riser 700 may include one or more acoustic transceiver systems 702 installed on the external surface of the marine riser 700. In embodiments, any of the acoustic transceiver systems 100, 200, 300, and 400 may be utilized as the one or more acoustic transceiver systems 702. In some embodiments, the one or more acoustic transceiver systems 702 may be positioned around the external surface of the marine riser 702 in rings. The rings of the one or more acoustic transceiver systems 702 may be spaced vertically to provide communications with devices inside the marine riser 700 at different vertical levels.

In some embodiments, the one or more acoustic transceiver systems 702 may be coupled to a modem 704. The modem 704 may provide a link between surface equipment and the one or more acoustic transceiver systems 702. In some embodiments, the modem 704 may also provide power to the one or more acoustic transceiver systems 702. As illustrated in FIG. 7A, in some embodiments, the modem 704 may be coupled to the one or more acoustic transceiver systems 702 by a wired connection 706. In other embodiments, the modem 704 may communicate with the one or more acoustic transceiver systems 702 wirelessly.

FIG. 7B illustrates another example of a configuration of one or more acoustic transceiver systems 752 on a marine riser 750. As illustrated in FIG. 7B, the marine riser 750 may include the one or more acoustic transceiver systems 752 installed on the external surface of the marine riser 700. Any of the acoustic transceiver systems 100, 200, 300, and 400 may be utilized as the one or more acoustic transceiver systems 752. In some embodiments, the one or more acoustic transceiver systems 752 may be positioned around the external surface of the marine riser 752 in rings. In some embodiments, the one or more acoustic transceiver systems 752 may be configured so as to form a solid ring around the external surface of the marine riser 750. The rings of the one or more acoustic transceiver systems 752 may be spaced vertically to provide communications with devices inside the marine riser 750 at different vertical levels.

In some embodiments, the one or more acoustic transceiver systems 752 may be coupled to a modem 754. The modem 754 may provide a link between surface equipment and the one or more acoustic transceiver systems 752. In some embodiments, the modem 754 may also provide power to the one or more acoustic transceiver systems 752. As illustrated in FIG. 7B, the modem 754 may be coupled to the one or more acoustic transceiver systems 752 by a wired connection 756. In some embodiments, the modem 754 may communicate with the one or more acoustic transceiver systems 752 wirelessly.

The examples discussed above and illustrated in FIGS. 7A and 7B are a few examples of the configuration and size of the acoustic transceiver systems. The acoustic transceiver systems may be any size or configuration based on the component of the hydrocarbon production system. For example, the acoustic transceiver systems may be any size or configuration to conform to the components of a BOP, for example, pipes, values, control system, and the like. Likewise, for example, the acoustic transceiver systems may be any size or configuration to conform to the components of a subsea tree, for example, pipes, values, control system, wellheads, and the like. Additionally, while the above embodiments and examples are described as operating on external surfaces of components of hydrocarbon production systems, the acoustic transceiver systems may be any size or configuration to operate on other surfaces of components of hydrocarbon production systems, for example, internal surfaces.

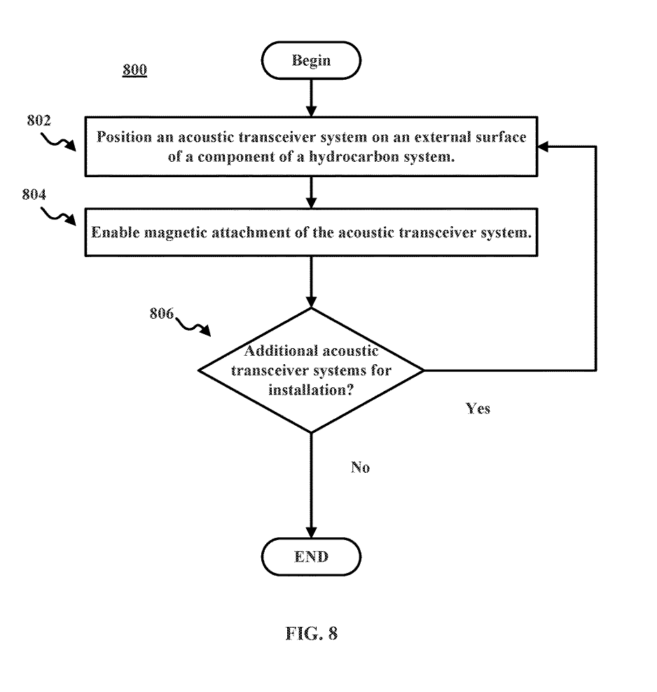

FIG. 8 illustrates a flowchart of a method 800 for installing one or more acoustic transceiver systems, according to an embodiment. The illustrated stages of the method are examples and any of the illustrated stages may be removed, additional stages may be added, and the order of the illustrated stages may be changed.

In 802, an acoustic transceiver system may be positioned on an external surface of a component of a hydrocarbon production system. In some embodiments, the acoustic transceiver system 100, 200, 300, and/or 400 may be positioned on the external surface of the component of the hydrocarbon production system. The acoustic transceiver system may be positioned on the external surface of the component of the hydrocarbon production system prior to installation of the component of the hydrocarbon production system. In other embodiments, the acoustic transceiver system may be positioned on the external surface of the component of the hydrocarbon production system during operation of the component of the hydrocarbon production system.

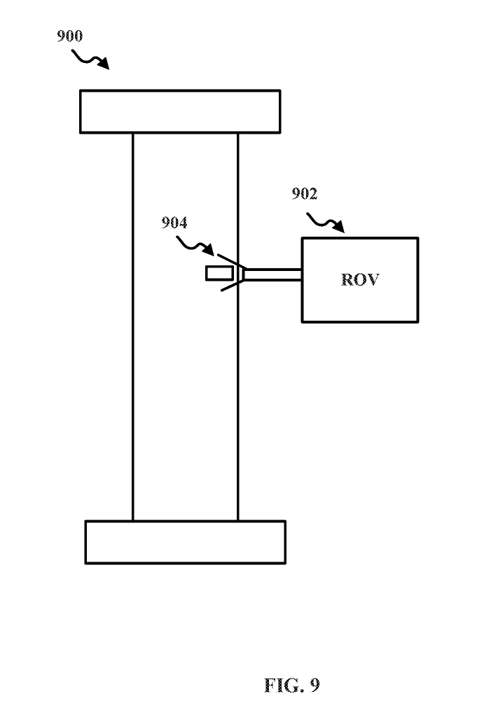

FIG. 9 illustrates an example of an installation of an acoustic transceiver system on a marine riser 900 in production, according to an embodiment. For example, as illustrated in FIG. 9, an ROV 902 may be utilized to position an acoustic transceiver system 904. The ROV 902 may hold and transport the transceiver system 904 with one of its arms. During the positioning, the magnetic field of the acoustic transceiver system 904 may be deactivated or blocked. For example, if the acoustic transceiver system 100 is the acoustic transceiver system 904, the blocking plate 112 may be positioned over the one or more magnets 110. If the acoustic transceiver system 200 is the acoustic transceiver system 904, the blocking plate 212 may be positioned over the magnet 210. If the acoustic transceiver system 300 is the acoustic transceiver system 904, the electro-magnetic properties of the one or more magnets 310 may be disabled. If the acoustic transceiver system 400 is the acoustic transceiver system 904, the electromagnetic properties of the magnet 410 may be disabled.

Referring back to FIG. 8, in 804, magnetic attachment of the acoustic transceiver system may be enabled. In some embodiments, the blocking plate may be removed prior to enable magnetic attachment once the acoustic transceiver system is positioned. In some embodiments, the electromagnetic properties may be enabled once the acoustic transceiver system is positioned.

For example, as illustrated in FIG. 9, the ROV 902 may enable the magnetic attachment of the acoustic transceiver system 904. The ROV 902 may enable the magnetic properties of the acoustic transceiver system 904 with one of its arms. For example, if the acoustic transceiver system 100 is the acoustic transceiver system 904, the blocking plate 112 may be removed by the ROV 902. If the acoustic transceiver system 200 is the acoustic transceiver system 904, the blocking plate 212 may be removed by the ROV 902. If the acoustic transceiver system 300 is the acoustic transceiver system 904, the ROV 902 may enable the power to the one or more magnets 310. If the acoustic transceiver system 400 is the acoustic transceiver system 904, the ROV 902 may enable the power to the magnet 410.

Referring back to FIG. 8, in 806, it may be determined if additional acoustic transceiver systems should be installed. If so, the method 800 returns to 802 and repeats.

The method and example discussed above and illustrated in FIG. 9 is one example of installing the acoustic transceiver systems on a marine riser utilizing an ROV. The acoustic transceiver systems may be installed on any component of the hydrocarbon production system using an ROV as discussed above. For example, the acoustic transceiver systems may be installed on the components of a BOP, for example, pipes, values, control system, and the like, using an ROV. Likewise, for example, the acoustic transceiver systems may be installed on the components of a subsea tree, for example, pipes, values, control system, wellheads, and the like, using an ROV. Additionally, while the above examples are described as being installed using any ROV, the method 800 may utilize any type of device, system, or personnel to install the acoustic transceiver systems.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principals of the disclosure and its practical applications, to thereby enable others skilled in the art to best utilize the disclosed embodiments and various embodiments with various modifications as are suited to the particular use contemplated.

What is claimed is:

1. An acoustic transceiver system, comprising:
at least one acoustic transceiver; and
at least one magnet coupled to the at least one acoustic transceiver and configured to attach the at least one acoustic transceiver to a component of a hydrocarbon production system.

2. The acoustic transceiver system of claim 1, further comprising:
a substrate coupled to the at least one acoustic transceiver and the at least one magnet, wherein a rear surface of the substrate is shaped to fit an external surface of the component of the hydrocarbon production system.

3. The acoustic transceiver system of claim 2, further comprising:
a blocking plate positioned between the rear surface of the substrate and the external surface of the component of the hydrocarbon production system.

4. The acoustic transceiver system of claim 2, wherein the at least one magnet is configured to cover the rear surface of the substrate.

5. The acoustic transceiver system of claim 1, wherein the at least one magnet forms a substrate for the at least one acoustic transceiver, wherein a rear surface of the at least one magnet is shaped to fit an external surface of the component of the hydrocarbon production system.

6. The acoustic transceiver system of claim 5, further comprising:
a blocking plate positioned between the at least one magnet and the external surface of the component of the hydrocarbon production system.

7. The acoustic transceiver system of claim 1, wherein the at least one magnet comprises at least one electro-magnet.

8. The acoustic transceiver system of claim 7, further comprising:
a power source coupled to the at least one electro-magnet.

9. The acoustic transceiver system of claim 1, further comprising:
a modem coupled to the at least one acoustic transceiver and configured to communicate with a control device.

10. The acoustic transceiver system of claim 1, wherein the component of the hydrocarbon production system is a marine riser.

11. The acoustic transceiver system of claim 1, wherein the component of the hydrocarbon production system is a subsea tree.

12. The acoustic transceiver system of claim 1, wherein the component of the hydrocarbon production system is a blowout preventer.

13. A method comprising:
positioning an acoustic transceiver system on an external surface of a component of a hydrocarbon production system; and
enabling at least one magnet of the acoustic transceiver system to attach the acoustic transceiver system on the external surface of the component of the hydrocarbon production system.

14. The method of claim 13, wherein the positioning of the acoustic transceiver system is performed by a remotely operated vehicle.

15. The method of claim 13, wherein at least one of the positioning of the acoustic transceiver system and enabling of the at least one magnet is performed by a remotely operated vehicle.

16. The method of claim 13, wherein the enabling of the at least one magnet comprises:
removing a blocking plate positioned between the at least one magnet and the external surface of the component of the hydrocarbon production system.

17. The method of claim 13, wherein the enabling of the at least one magnet comprises:
enabling power to the at least one electromagnet.

18. The method of claim 13, wherein the component of the hydrocarbon production system is a marine riser.

19. The method of claim 13, wherein the component of the hydrocarbon production system is a subsea tree.

20. The method of claim 13, wherein the component of the hydrocarbon production system is a blowout preventer.
